(19) United States
(12) Patent Application Publication
(10) Pub. No.: US 2014/0302183 A1
(43) Pub. Date: Oct. 9, 2014

(54) Compound, Insulation, or Sealant and Deterrent, Repellent, or Barrier for Rodents, Mammals, Insects, or other Annoying Pests

(71) Applicant: Dustin Alan Reynolds, (US)

(72) Inventor: Dustin Alan Reynolds, (US)

(21) Appl. No.: 13/856,323

(22) Filed: Apr. 3, 2013

(51) Int. Cl. A01N 37/18; A01N 65/38

(52) U.S. Cl. CPC A01N 37/18; A01N 65/38
USPC 424/760; 514/627

(57) ABSTRACT

This invention is formula and method for dispensing, injecting, or otherwise installing a formula comprising a mixture of compounds, foams, caulks, sealants, insulations, gels or other such mediums along with poisons, barriers, repellents, or deterrents in order to facilitate sealing or insulating as well as the additional benefit of killing, blocking, deterring, repelling or otherwise hindering said rodents, mammals, insects, and/or pests.

### CROSS-REFERENCE TO RELATED APPLICATIONS

This non-provisional application claims the benefit and application date of the provisional application previously filed under application No. 61/620,309 filed on Apr. 4, 2012.

### STATEMENT REGARDING FEDERALLY SPONSORED RESEARCH OR DEVELOPMENT (NOT APPLICABLE)

None. NO federal funding was used.

### REFERENCE TO SEQUENCE LISTING, A TABLE, OR A COMPUTER PROGRAM LISTING COMPACT DISC APPENDIX (NOT APPLICABLE)

Not applicable.

### BACKGROUND OF THE INVENTION

Compounds, foams, caulks, sealants, and insulations typically do well to cover or seal cracks to keep out cold or heat or to keep out wind or moisture; however, they typically fail in keeping out rodents, insects, and other creatures. In fact, rodents, insects, and creatures often make their homes in said compounds, foams, caulks, and insulation or use pieces of said compounds, foams, caulks, and insulation in order to construct the nest or homes in which they live. This invention expands the capabilities of compounds, foams, caulks, sealants, and insulations through the use of one or more additives in order to further provide a means of deterring, repelling, or otherwise providing a barrier to against said rodents, insects, and creatures.

### BRIEF SUMMARY OF THE INVENTION

This invention comprises a formula and method for dispensing, injecting, or otherwise installing a formula comprising a mixture of compounds, foams, caulks, sealants, and insulations along with poisons, barriers, repellants, or deterrents in order to provide a means of both sealing or insulating in addition to blocking or hindering said rodents, mammals, insects, and/or pests. One possible implementation includes but is not limited to foam embedded with one or more deterrents, repellents, or barriers such as steel wool allowing cracks or holes to be sealed while also deterring, repelling, or preventing rodents, insects, or other creatures from making their way through, or around the foam, barrier, repellent, or deterrent.

### BRIEF DESCRIPTION OF THE SEVERAL VIEWS OF THE DRAWING

The present drawings now will be described, in which some examples of the embodiments of the inventions are shown. These inventions may be embodied in many different forms and should not be construed as limited to the embodiments set forth herein; rather, these embodiments are provided by way of example so that this disclosure will satisfy applicable legal requirements. Having thus described the invention in general terms, reference will now be made to the accompanying drawings, which are not necessarily drawn to scale, and wherein

FIG. 1 illustrates one possible use of the invention. The invention is not constrained to being used in this embodiment. In this example, a sealant is installed along with a deterrent in a crack to repel or otherwise hinder the destructive progress of a rodent.

FIG. 2 illustrates one of several possible methods of dispensing. In this example, a deterrent is installed by hand and then sealant or foam is combined and installed and intermingled with the deterrent.

FIG. 3 illustrates one of several possible methods of dispensing. In this example, the ingredients are combined prior to installation.

FIG. 4 illustrates one of several possible methods of dispensing. In this example, a sealant mixes with a deterrent before or as it is installed or injected.

### DETAILED DESCRIPTION OF THE INVENTION

The present inventions now will be described more fully hereinafter with reference to the accompanying drawings, in which some examples of the embodiments of the inventions are shown. These inventions may be embodied in many different forms and should not be construed as limited to the embodiments set forth herein; rather, these embodiments are provided by way of example so that this disclosure will satisfy applicable legal requirements.

This invention is a formula comprised two basic ingredients or ingredient combinations. The first ingredient or ingredient combination may contain one or more insulations, sealants, foams, caulks, seals for a joint, juncture, or hole, other compounds, other mixtures, other mediums, or a mixture or combination of these ingredients. The second ingredient or ingredient combination may contain one or more poisons, barriers, repellents, or deterrents.

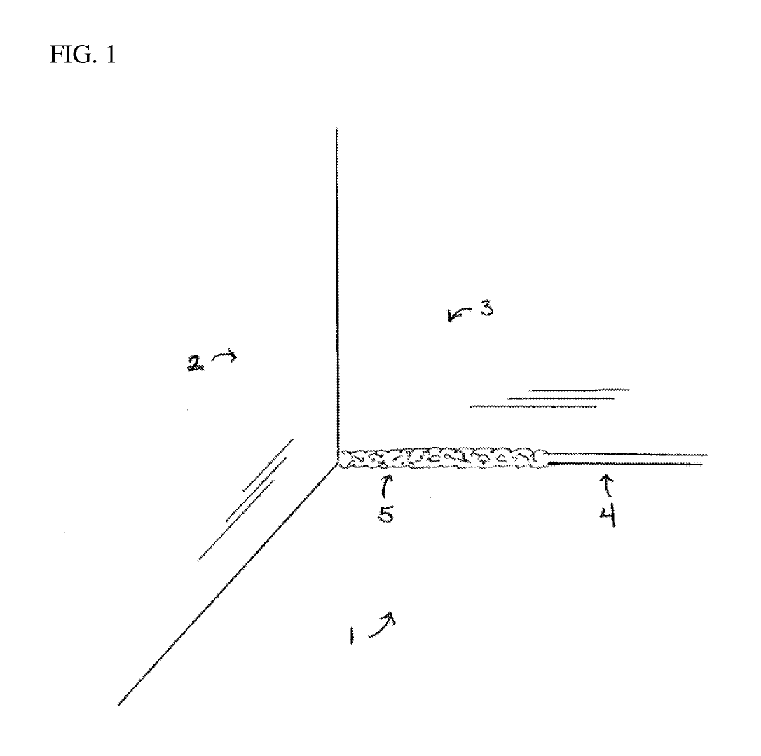

When the second ingredient or ingredient combination is mixed or combined with, into, onto, or alongside the first ingredient or ingredient combination, the resulting compound is an insulation, sealant, foam, caulk or other compound that has the additional ability to block, kill, or deter a rodents, mammals, insects, or other annoying pests [FIG 1].

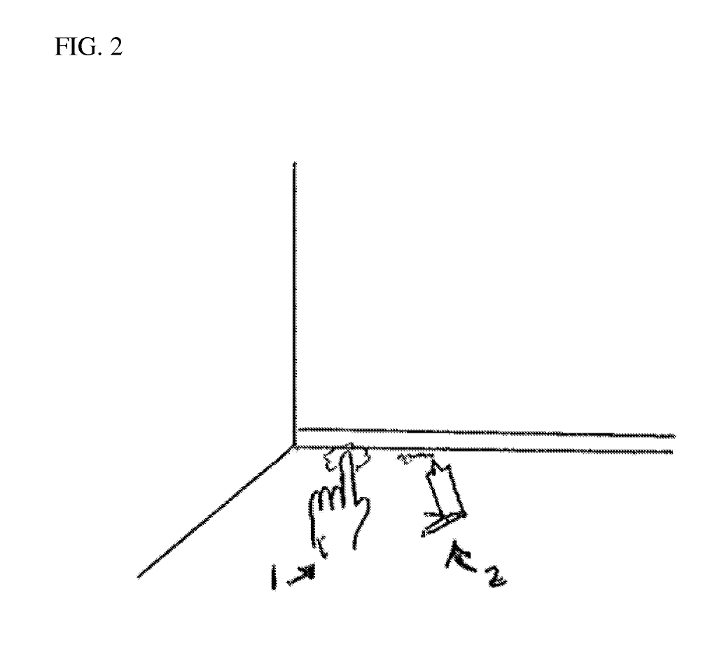

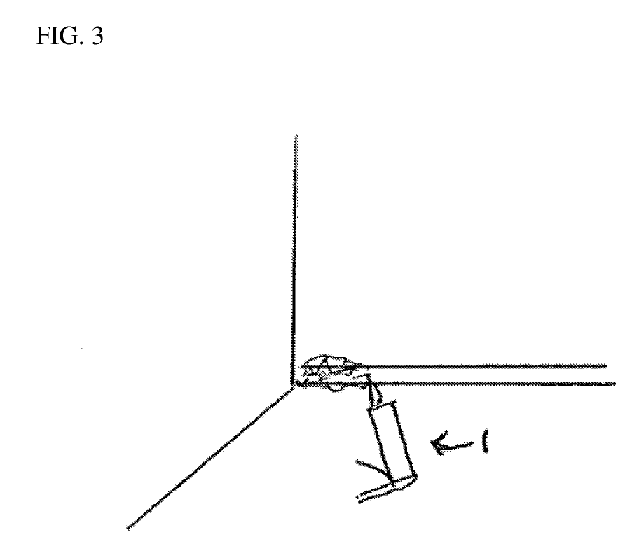

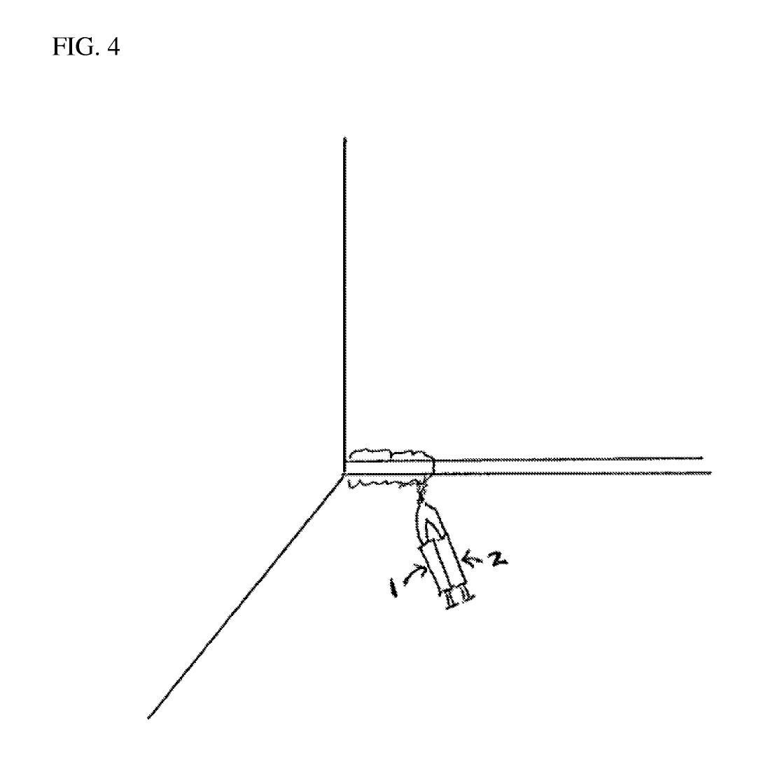

This invention also comprises a means of combining and/or dispensing the two ingredients or ingredient groups, separately [FIG. 2, FIG. 4] or together [FIG 3], so that they can be used in combination to achieve the required improvement.

The mixture or medium previously described as the first ingredient may consist of, but is not limited to any of the following: foam, expandable foam, insulation, caulk, gel, powder, or other such medium. Examples of the second ingredient described above may consist of, but is no limited to steel wool, metal balls, balls, poison, capsaicin, pepper, chili, wire, mesh, fibers, pellets, chunks, or other deterrents, repellents, or barriers.

1. A formula comprising:
a. one or more insulations, sealants, foams, caulks, seals for a joint, juncture, or hole, other compounds, other mixtures, other mediums, or a mixture or combination of these ingredients,
b. one or more poisons, deterrents, repellents, or barriers,
whereby, when the one or more of the ingredients of 1a and one or more ingredients 1b are mixed or combined into, onto, under, on top of, around, interspersed with, intermingled with, or alongside one another, the invention provides a means of achieving the additional benefit of blocking, killing, deterring, repelling, or otherwise hindering the progress, activities, or destructive abilities of a rodent, mammal, insect, or other annoying pest.

2. The formula of claim 1 wherein the poisons, barriers, or deterrents may include but are not limited to steel wool, metal balls, balls, poison, capsaicin, pepper, chili, wire, mesh, fibers, pellets, chunks, sound producing mediums, or other deterrents, repellents, or barriers.

3. The formula of claim 1 wherein a means is provided to combine and dispense, inject, or install or to separately dispense, inject, or install the ingredients of said formula whereby one or more ingredients may be mixed or combined with, into, onto, under, on top of, around, interspersed with, intermingled with, or alongside another ingredient or ingredients.

4. The formula of claim 1 wherein the order in which the ingredients are mixed or combined into, onto, under, on top of, around, interspersed with, intermingled with, alongside one of more other ingredients is not important.
